(19) United States
(12) Patent Application Publication
(10) Pub. No.: US 2026/0238375 A1
(43) Pub. Date: Aug. 13, 2026

(54) A Compact Optical Multiplexer - Demultiplexer System

(71) Applicant: Optimal Coatech (Guangzhou) Co., Ltd., Guangzhou, Guangdong (CN)

(72) Inventors: Xiaohu Chen, Guangzhou, Guangdong (CN); Wenmin Ou, Guangzhou, Guangdong (CN)

(21) Appl. No.: 19/471,525

(22) PCT Filed: Jun. 29, 2023
(86) PCT No.: PCT/CN2023/103837

§ 371 Date: Oct. 1, 2025

(51) Int. Cl. H04J 14/02; G02B 1/11; H04B 10/50; H04B 10/61

(52) U.S. Cl. CPC H04J 14/0307; G02B 1/11; H04B 10/503; H04B 10/506; H04B 10/61

(57) ABSTRACT

In an optical multiplexer-demultiplexer system, an optical multiplexer system includes a first set of bandpass filters and an optical multiplexer for combining different wavelengths of input optical or laser signals T into a single output optical or laser signal O1 after bandpass filtering of the input optical or laser signals T by the first set of bandpass filters. An optical demultiplexer system includes a second set of bandpass filters and an optical demultiplexer for outputting the output optical or laser signal Ol via a COM port after passage through one of the second set of bandpass filters. The optical demultiplexer is also operative or configured to receive via the COM port an input optical signal comprising a number of different wavelength optical or laser signals R. Via the optical demultiplexer and the second set of bandpass filters, the different wavelength optical or laser signals R can be separated and output separately by the optical demultiplexer system.

### CROSS-REFERENCE TO RELATED APPLICATION

This application is the United States national phase of International Patent Application No. PCT/CN 2023/103837 filed Jun. 29, 2023, the disclosure of which is hereby incorporated by reference in its entirety.

### BACKGROUND

### Field

The present disclosure describes an optical multiplexer-demultiplexer system and, more specifically, an optical multiplexer-demultiplexer system having small size and high performance.

### Description of Related Art

Existing passive optical networks (PON) include three parts, namely, a multiplexer, a demultiplexer, and a beam combiner in an optical path between the multiplexer and the demultiplexer.

In an example, three input optical or laser signals T1, T2 and T3, of different wavelengths, may be input to the multiplexer which multiplexes the three input optical or laser signals T1, T2 and T3 into a single output optical or laser signal Ol exiting the multiplexer to the combiner. The combiner, via a bandpass filter, outputs the single optical or laser signal O1 exiting the multiplexer to a COM port of the combiner.

The COM port can also receive as input a single input optical or laser signal R comprising, in an example, three different wavelength optical or laser signals R1, R2 an R3. The bandpass filter, which is tuned to pass the wavelengths of the input optical or laser signals T1, T2 and T3 and reflect the wavelengths of the different wavelength optical or laser signals R1, R2 and R3 of the single input optical or laser signal R, reflects the single input optical or laser signal R to one or more mirrors which reflect the single input optical or laser signal R to the demultiplexer. The demultiplexer divides the single input optical or laser signal R into the different wavelength optical or laser signals R1, R2 and R3 and separately outputs the different wavelength optical or laser signals R1, R2 and R3, e.g., to three separate photo diodes.

In an example, the COM port can be connected to an external optical fiber which can simultaneously or separately transport or covey the single output optical or laser signal O1, including the multiplexed input optical or laser signals T1, T2 and T3 of different wavelengths, away from the combiner and/or transport or covey the single input optical or laser signal R, including the three different wavelength optical or laser signals R1, R2 an R3, to the combiner.

In existing PONs, the wavelength span of an input signal and an output signal may only be 10 nm, which cannot be divided or separated by a common 45 degree filter, and can only be divided by a small Angle filter (AOI:<15°)+mirror. In the multiplexer, the wavelength spans of at least some of the input optical or laser signals may be 4 nm and 2nm, Such narrow wavelength spans can make filters of the demultiplexer difficult to fabricate for 1270 nm and 1310 nm channels. In particular, such narrow wavelength spans can make it hard to achieve an isolation of 30 dB that is required by many applications. In these applications, an additional filter is need to improve isolation of the 1310 nm channel.

Moreover, existing PONs have a relatively large size and are designed for coupling with a photodiode (PD) chip and may not be suitable for coupling with a TO can PD.

### SUMMARY

Disclosed herein is an optical multiplexer-demultiplexer system comprising an optical multiplexer system comprising bandpass filters BF1, BF2 and BF3 and an optical multiplexer operative or configured for combining different wavelengths of input optical or laser signals T1, T2 and T3 into a single output optical or laser signal O1 after passage of the input optical or laser signals T1, T2 and T3 through the bandpass filters BF1, BF2 and BF3 which are operative or configured for bandpass filtering the input optical or laser signals T1, T2 and T3 prior to entry into the optical multiplexer. The optical multiplexer-demultiplexer system also comprises an optical demultiplexer system comprising bandpass filters BF4, BF5, BF6 and BF7, first and second reflective elements, an anti-reflective (AR) coating, and an optical demultiplexer. The optical demultiplexer is operative or configured for receiving and passing the single output optical or laser signal Ol to a COM port of the optical demultiplexer system via the AR coating after passage of the single output optical or laser signal O1 through the bandpass filter BF4.

The optical demultiplexer is also operative or configured to receive on the COM port an input optical or laser signal R comprising different wavelength optical or laser signals R1, R2 and R3, to pass the input optical or laser signal R to the bandpass filter BF4 after passage of the input optical or laser signal R via the AR coating. The bandpass filter BF4 is operative or configured to reflect the input optical or laser signal R to the bandpass filter BF5 which is operative or configured for reflecting optical or laser signals R1 and R3 to the bandpass filter BF6 via the first and second reflective elements and for passing the optical or laser signal R2. The bandpass filter BF6 is operative or configured for reflecting the optical or laser signal R3 to the bandpass filter BF7 and for passing the optical or laser signal R1. The bandpass filter BF7 is operative or configured for passing the optical or laser signal R3.

Also disclosed herein is an optical multiplexer-demultiplexer system comprising an optical multiplexer and bandpass filters BF1, BF2 and BF3 operative or configured for bandpass filtering input optical or laser signals T1, T2 and T3 having different wavelengths prior to entry into the optical multiplexer. The optical multiplexer is operative or configured for combining the bandpass filtered input optical or laser signals T1 and T2 after reflection of the bandpass filtered optical or laser signal T1, combining the bandpass filtered input optical or laser signal T3 with the combined bandpass filtered input optical or laser signals T1 and T2 after reflection of the combined bandpass filtered input optical or laser signals T1 and T2, and output the combined bandpass filtered input optical or laser signals T1, T2 and T3 as a single output optical or laser signal O1. The optical multiplexer-demultiplexer system also comprises an optical demultiplexer system comprising bandpass filters BF4, BF5, BF6 and BF7, an anti-reflective (AR) coating, and an optical demultiplexer operative or configured for receiving the single output optical or laser signal O1 after passage through the bandpass filter BF4. The optical demultiplexer is operative or configured for passing the single output optical or laser signal O1 to a COM port of the optical demultiplexer via the AR coating.

The optical demultiplexer is also operative or configured for receiving on the COM port an input optical or laser signal R comprising different wavelength optical or laser signals R1, R2 and R3, to pass the input optical or laser signal R to the bandpass filter BF4 after passage of the input optical or laser signal R via the AR coating. The bandpass filter BF4 is operative or configured to reflect the input optical or laser signal R to the bandpass filter BF5 which is operative or configured for reflecting optical or laser signals R1 and R3 to the bandpass filter BF6 via first and second reflective elements of the optical demultiplexer and for passing the optical or laser signal R2. The bandpass filter BF6 is operative or configured for reflecting the optical or laser signal R3 to the bandpass filter BF7 and for passing the optical or laser signal R1. The bandpass filter BF7 is operative or configured for passing the optical or laser signal R3.

Also disclosed herein is an optical multiplexer-demultiplexer system comprising an optical multiplexer (Tx) having a Tx body including a Tx1 surface and a Tx2 surface, and bandpass filters BF1, BF2 and BF3 disposed on the Tx1 surface for receiving input optical or laser signals T1, T2 and T3, respectively. The input optical or laser signals T1, T2 and T3, after passage through the bandpass filters BF1, BF2 and BF3, enter the Tx1 surface and pass through the Tx body, wherein the input optical or laser signal T1, after reflection at the Tx2 surface back to the Tx1 surface via the Tx body, is combined with the input optical or laser signal T2 entering the Tx1 surface. The combined input optical or laser signals T1 and T2, after reflection at the Tx2 surface back to the Tx1 surface via the Tx body, is combined with the input optical or laser signal T3 entering the Tx1 surface. The combined input optical or laser signals T1, T2, and T3 exit the Tx2 surface via the Tx body as an output optical or laser signal O1.

The optical multiplexer-demultiplexer system also comprises an optical demultiplexer (Rx) having an Rx body including an Rx1 surface and an Rx2 surface, bandpass filters BF4 and BF6 disposed on the Rx1 surface, and bandpass filters BF5 and BF7 and an anti-reflective (AR) coating disposed on the Rx2 surface. The optical demultiplexer is operative or configured for receiving and passing the single output optical or laser signal O1 to a COM port of the optical demultiplexer system via the Rx body and the AR coating after passage of the single output optical or laser signal O1 through the bandpass filter BF4.

The optical demultiplexer is also operative or configured to receive on the COM port an input optical or laser signal R comprising different wavelength optical or laser signals R1, R2 and R3, and to pass the input optical or laser signal R to the bandpass filter BF4 via the AR coating and the Rx body. The bandpass filter BF4 is operative or configured to reflect the input optical or laser signal R to the bandpass filter BF5 via the Rx body. The bandpass filter BF5 is operative or configured for reflecting optical or laser signals R1 and R3 to the bandpass filter BF6 via first and second reflective elements and for passing the optical or laser signal R2. The bandpass filter BF6 is operative or configured for reflecting the optical or laser signal R3 to the bandpass filter BF7 and for passing the optical or laser signal R1. Finally, the bandpass filter BF7 is operative or configured for passing the optical or laser signal R3.

Also disclosed herein is a method of optical multiplexing and demultiplexing optical or laser signals with an optical multiplexer (Tx) having a Tx body including a Tx1 surface, a Tx2 surface and bandpass filters BF1 and BF3 disposed on the Tx1 surface, and an optical demultiplexer (Rx) having an Rx body including an Rx1 surface and an Rx2 surface, bandpass filter BF4 and BF6 disposed on the Rx1 surface and a bandpass filter BF5 disposed on the Rx2 surface. The method includes a) inputting, via the Tx1 surface, different wavelength optical or laser signals T1 and T3 into the Tx body via the respective bandpass filters BF1 and BF3; b) combining, at or adjacent the Tx1 surface, reflections of the optical or laser signal T1 by or adjacent the Tx2 surface and the bandpass filter BF3 with the optical or laser signal T3 entering the Tx1 surface; c) outputting, via the optical demultiplexer Rx after passage through the Tx2 surface, the bandpass filter BF4, the Rx1 surface and the Rx2 surface, the combined optical or laser signals T1 and T3 of step b); d) inputting, via the Rx2 surface, an optical or laser signal R comprising different wavelength optical or laser signals R1 and R2; e) reflecting, by the bandpass filter BF4, the optical or laser signal R of step d) to the bandpass filter BF5 via the Rx body; f), following step e), by the bandpass filter BF5, passing the optical or laser signal R2 and reflecting the optical or laser signals R1 to the bandpass filter BF6 via the Rx body; and g), following step f), by the bandpass filter BF6, passing the optical or laser signal R1.

### BRIEF DESCRIPTION OF THE DRAWINGS

FIG. 1 is one non-limiting embodiment or example of an optical multiplexer-demultiplexer system in accordance with the principles of the present disclosure;

FIG. 2 is another non-limiting embodiment or example of an optical multiplexer-demultiplexer system in accordance with the principles of the present disclosure; and

FIG. 3 is a method in accordance with the principles of the present disclosure.

### DESCRIPTION

Various non-limiting examples will now be described with reference to the accompanying figures where like reference numbers correspond to like or functionally equivalent elements.

For purposes of the description hereinafter, terms like “end,” “upper,” “lower,” “right,” “left,” “vertical,” “horizontal,” “top,” “bottom,” “lateral,” “longitudinal,” and derivatives thereof shall relate to the example(s) as oriented in the drawing figures. However, it is to be understood that the example(s) may assume various alternative variations and step sequences, except where expressly specified to the contrary. It is also to be understood that the specific example(s) illustrated in the attached drawings, and described in the following specification, are simply exemplary examples or aspects of the disclosure. Hence, the specific examples or aspects disclosed herein are not to be construed as limiting.

Further, as used herein, all numbers expressing dimensions, physical characteristics, processing parameters, quantities of ingredients, reaction conditions, and the like, used in the specification and claims are to be understood as being modified in all instances by the term “approximately” or “about”. Accordingly, unless indicated to the contrary, the numerical values set forth in the following specification and claims may vary depending upon the desired properties sought to be obtained by the present disclosure. At the very least, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. “A” or “an” refers to one or more.

As used herein, “coupled”, “coupling”, and similar terms refer to two or more elements that are joined, linked, fastened, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the phrase “at least one of”, when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations.

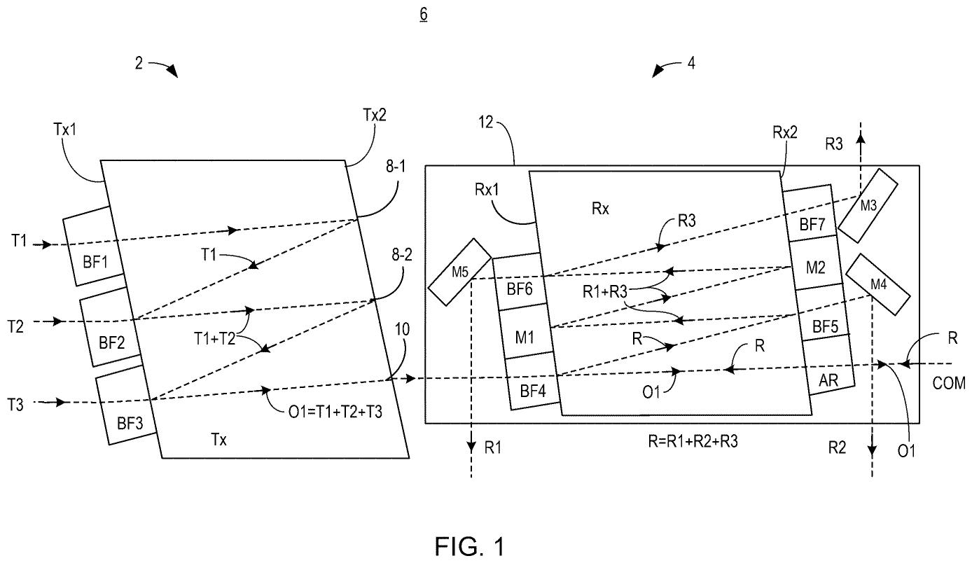

With reference to FIG. 1, one non-limiting embodiment or example optical multiplexer-demultiplexer system in accordance with the principles of the present disclosure includes an optical multiplexer 2 and an optical demultiplexer 4 positioned in operative relation to each other on a substrate 6.

The optical multiplexer 2 includes a body Tx formed of any suitable and/or desirable optical material, e.g., glass, that facilitates the propagation of optical or laser signals T1, T2, and T3 with no more than a desirable level of loss or scattering of the optical or laser signals. The body Tx includes surfaces Tx1 and Tx2 disposed or positioned in spaced relation, preferably in spaced parallel relation. The optical multiplexer 2 also includes bandpass filters BF1, BF2 and BF3 disposed on the Tx1 surface for receiving input optical or laser signals T1, T2 and T3, respectively. The Tx2 surface includes reflective portions 8-1 and 8-2 for reflecting the optical or laser signals T1 and the combination of optical or laser signals T1-T2 after passage through the body Tx in the manner described hereinafter.

Each reflective portion 8-1 and 8-2 may be formed by an optically reflective film formed or disposed on appropriate positions of the Tx2 surface. The Tx2 surface may also include a portion 10 that is operative or configured to pass an output optical or laser signal O1 which includes input optical or laser signals T1, T2 and T3 multiplexed thereon. In an example, this portion 10 may include an anti-reflective (AR) coating that facilitates the passage of the output optical or laser signal O1 to the optical demultiplexer 4.

In one non-limiting example, the wavelengths of the input optical or laser signals T1, T2 and T3 may be 1342+2 nm, 1490±10 nm, and 1577±2.5 nm. However, this is not to be construed in a limiting sense since it is envisioned that one or more of the input optical or laser signals T1, T2 and T3 may have different wavelengths. The bandpass filters BF1, BF2 and BF3 may be configured to pass the respective wavelengths of the input optical or laser signals T1, T2 and T3 and to reflect optical or laser signals of different wavelengths.

The optical demultiplexer 4 includes a body Rx formed of any suitable and/or desirable optical material, e.g., glass, that facilitates the propagation of an input optical or laser signal R, comprising different wavelength optical or laser signals R1, R2 and R3 modulated on the input optical or laser signal R with no more than a desirable level of loss or scattering of the optical or laser signals. The body Rx includes surfaces Rx1 and Rx2 disposed or positioned in spaced relation, preferably in spaced parallel relation.

In an example, the optical demultiplexer 4 may include bandpass filters BF4 and BF6 and a mirror M1 are disposed or positioned on the Rx1 surface. The optical demultiplexer 4 may also include bandpass filters BF5 and BF7, a mirror M2, and an AR coating are disposed or positioned on the Rx2 surface. The optical demultiplexer 4 may also include mirrors M3, M4 and M5 positioned in operative relation to bandpass filters BF7, BF5 and BF6, The optical demultiplexer 4 may also include a COM port to facilitate the output of the optical or laser signal O1 from to the optical demultiplexer 4, e.g., output optical or laser signal O1 to an external optical fiber (not shown) coupled to the COM port, and to facilitate the receipt of the input optical or laser signal R to the optical demultiplexer 4, e.g., from the external optical fiber.

In one non-limiting example, the wavelengths of optical or laser signals R1, R2 and R3 may be 1270±10 nm, 1286±2 nm, and 1310±20 nm. However, this is not to be construed in a limiting sense since it is envisioned that one or more of optical or laser signals T1, T2 and T3 may have different wavelengths. The bandpass filter BF4 may be configured to pass the wavelengths of the optical or laser signals T1, T2 and T3 modulated on the output optical or laser signal O1 and may be configured to reflect all other wavelengths of optical or laser signals, including the wavelengths of the optical or laser signals R1, R2 and R3 modulated on the input optical or laser signal R. The bandpass filters BF5, BF6 and BF7 may be configured to pass the wavelengths of the respective optical or laser signals R2, R1 and R3, and to reflect optical or laser signals of different wavelengths.

The optical demultiplexer 4 may include a substrate 12 to support the body Rx, including the bandpass filters BF4-BF7, the mirrors M1-M2, and the AR coating on the surfaces Rx1 and Rx2 as described above, along with supporting the COM port and the mirrors M3-M5 spaced from the surfaces Rx1 and Rx2.

Having thus described the optical multiplexer 2 and the optical demultiplexer 4, the operation of the optical multiplexer 2 and the optical demultiplexer 4 will now be described.

With reference to the optical multiplexer 2, the input optical or laser signals T1, T2 and T3, after passage through the bandpass filters BF1, BF2 and BF3, enter the Tx1 surface and pass through the Tx body to the Tx2 surface. In an example, the input optical or laser signal Tl is reflected at the Tx2 surface back to the bandpass filter BF2, via the Tx body, where the input optical or laser signal T1 is reflected by the bandpass filter BF2 and combined (multiplexed) with the input optical or laser signal T2 entering the Tx1 surface via the bandpass filter BF2.

The combined input optical or laser signals T1 and T2 is reflected at the Tx2 surface back to the bandpass filter BF3, via the Tx body, where the combined input optical or laser signals T1 and T2 are reflected by the bandpass filter BF3 and combined with the input optical or laser signal T3 entering the Tx1 surface via the bandpass filter BF3. The combined input optical or laser signals T1, T2, and T3 exit the Tx2 surface via the Tx body as the single output optical or laser signal Ol having the input optical or laser signals T1, T2, and T3 modulated thereon.

With reference to the optical demultiplexer 4, the output optical or laser signal Ol from the optical multiplexer 2 passes through the bandpass filter BF4 and exits the optical demultiplexer 4 via the COM port.

The optical demultiplexer is also operative or configured to receive on the COM port the input optical or laser signal R, comprising different wavelength optical or laser signals R1, R2 and R3, to pass the input optical or laser signal R to the bandpass filter BF4 via the AR coating and the Rx body. Because the bandpass filter BF4 is configured to only pass the wavelengths of the input optical or laser signals T1, T2 and T3 modulated on the output optical or laser signal O1 and, hence, will reflect the wavelengths of the optical or laser signals R1, R2 and R3 modulated on the input optical or laser signal R, the bandpass filter BF4 reflects the input optical or laser signal R to the bandpass filter BF5 via the Rx body.

The bandpass filter BF5 is operative or configured to reflect the wavelengths of the optical or laser signals R1 and R3 to the bandpass filter BF6, via the Rx body and the mirrors M1 and M2, and to pass the wavelength of the optical or laser signal R2 to the mirror M4. After reflection by the mirror M4, the optical or laser signal R2 exits the optical demultiplexer for further receipt and/or processing, e.g., by a first photodiode.

The bandpass filter BF6 is operative or configured for reflecting the wavelength of the optical or laser signal R3 to the bandpass filter BF7 and for passing the wavelength of the optical or laser signal R1 to the mirror M5. After reflection by the mirror M5, the optical or laser signal R1 exits the optical demultiplexer for further receipt and/or processing, e.g., by second photodiode.

Finally, the bandpass filter BF7 is operative or configured for passing the wavelength of the optical or laser signal R3 to the mirror M3. After reflection by the mirror M3, the optical or laser signal R3 exits the optical demultiplexer for further receipt and/or processing, e.g., by third photodiode.

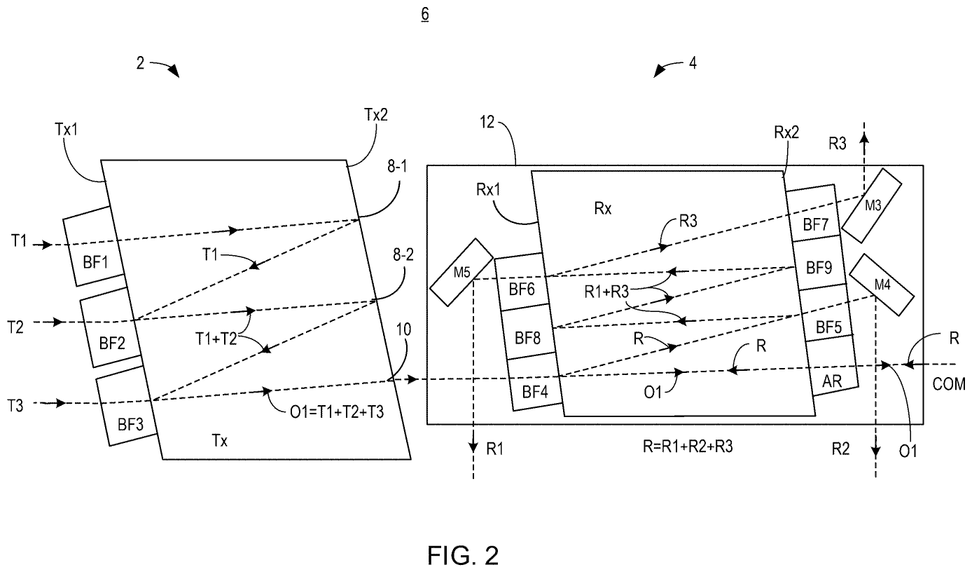

With reference to FIG. 2 and with continuing reference to FIG. 1, except as follows, another non-limiting embodiment or example optical multiplexer-demultiplexer system in accordance with the principles of the present disclosure is similar in most respects the example optical multiplexer-demultiplexer system shown in FIG. 1.

In the optical demultiplexer 4 of FIG. 2, however, bandpass filters BF8 and BF9 replace mirrors M1 and M2 in the optical demultiplexer 4 of FIG. 1. In an example, bandpass filters BF8 and BF9 are each configured to reflect at least the wavelengths of the optical or laser signals R1 and R3 and to pass other wavelength optical or laser signal that may be present with the optical or laser signals R1 and R3.

In FIGS. 1 and 2, mirrors M1 and M2 and bandpass filters BF8 and BF9 are alternate forms of respective first and second reflective elements, i.e., mirror M1 and bandpass filter BF8 being alternate forms of the first reflective element, and mirror M2 and bandpass filter BF9 being alternate forms of the second reflective element. Other than bandpass filters BF8 and BF9 replacing mirrors M1 and M2, the optical multiplexer-demultiplexer systems in FIGS. 1 and 2 are the same.

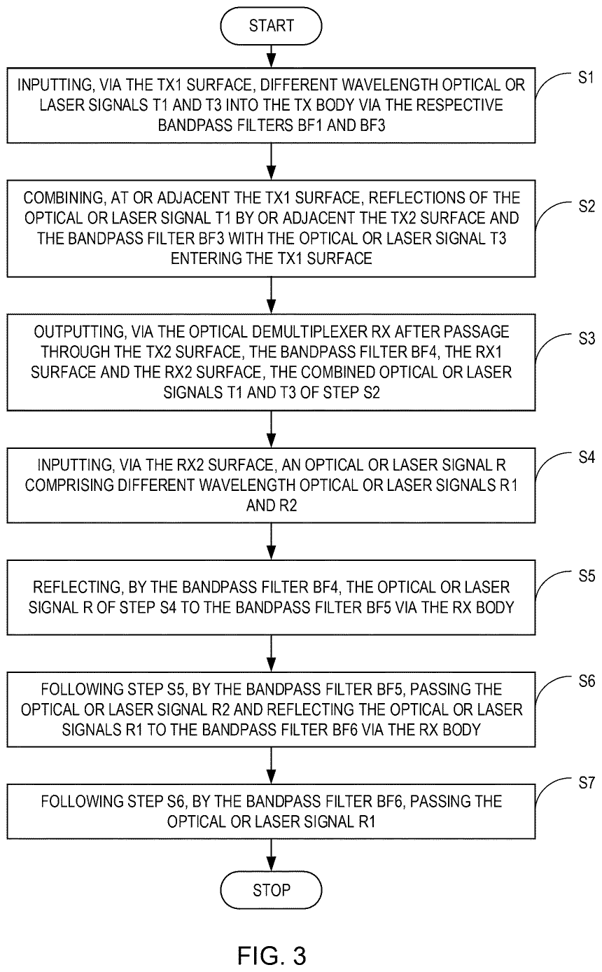

A method in in accordance with the principles of the present disclosure will now be described with reference to FIG. 3 and with continuing reference to FIGS. 1 and 3. The method begins by advancing from a Start step to a step S1 comprising inputting, via the Tx1 surface, different wavelength optical or laser signals T1 and T3 into the Tx body via the respective bandpass filters BF1 and BF3.

The method then advances to step S2, which includes combining, at or adjacent the Tx1 surface, reflections of the optical or laser signal T1 by or adjacent the Tx2 surface and the bandpass filter BF3 with the optical or laser signal T3 entering the Tx1 surface.

The method then advances to step S3, comprising outputting, via the optical demultiplexer Rx after passage through the Tx2 surface, the bandpass filter BF4, the Rx1 surface and the Rx2 surface, the combined optical or laser signals T1 and T3 of step S2.

The method then advances to step S4, comprising inputting, via the Rx2 surface, an optical or laser signal R comprising different wavelength optical or laser signals R1 and R2.

The method then advances to step S5, comprising reflecting, by the bandpass filter BF4, the optical or laser signal R of step S4 to the bandpass filter BF5 via the Rx body.

The method then advances to step S6, comprising, following step S5, by the bandpass filter BF5, passing the optical or laser signal R2 and reflecting the optical or laser signals R1 to the bandpass filter BF6 via the Rx body.

The method then advances to step S6, comprising, following step S6, by the bandpass filter BF6, passing the optical or laser signal R1.

The method then advances to the Stop step.

The foregoing method was described in connection with an multiplexer-demultiplexer system comprising optical or laser signals T1 and T3, optical multiplexer Tx having the Tx body including the Tx1 surface, the Tx2 surface and the bandpass filters BF1 and BF3 disposed on the Tx1 surface, and the optical demultiplexer Rx comprising optical or laser signals R, R1 and R2, the Rx body including the Rx1 surface and the Rx2 surface, the bandpass filter BF4 and BF6 disposed on the Rx1 surface and the bandpass filter BF5 disposed on the Rx2 surface. However, this is not to be construed in a limiting sense since it is envisioned that the method can include additional steps described above in connection with the description of FIGS. 1 and 2 as may be suitable and/or desirable when the optical multiplexer Tx also includes one or more of the optical or laser signal T2 and/or the bandpass filter BF2, and when the optical demultiplexer Rx also includes one or more of the optical or laser signal R3, the bandpass filter BF7, reflective elements (e.g., mirror M1, mirror M2, bandpass filter BF8 and/or bandpass filter BF9), the mirrors M3, M4 and M5, the AR coating, and/or the COM port.

Although the disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. An optical multiplexer-demultiplexer system comprising:
an optical multiplexer system comprising bandpass filters BF1, BF2 and BF3 and an optical multiplexer operative or configured for combining different wavelengths of input optical or laser signals T1, T2 and T3 into a single output optical or laser signal O1 after passage of the input optical or laser signals T1, T2 and T3 through the bandpass filters BF1, BF2 and BF3 which are operative or configured for bandpass filtering the input optical or laser signals T1, T2 and T3 prior to entry into the optical multiplexer; and
an optical demultiplexer system comprising bandpass filters BF4, BF5, BF6 and BF7, first and second reflective elements, an anti-reflective (AR) coating, and an optical demultiplexer, wherein the optical demultiplexer is operative or configured for receiving and passing the single output optical or laser signal O1 to a COM port of the optical demultiplexer system via the AR coating after passage of the single output optical or laser signal O1 through the bandpass filter BF4, wherein:
the optical demultiplexer is also operative or configured to receive on the COM port an input optical or laser signal R comprising different wavelength optical or laser signals R1, R2 and R3, to pass the input optical or laser signal R to the bandpass filter BF4 after passage of the input optical or laser signal R via the AR coating;
the bandpass filter BF4 is operative or configured to reflect the input optical or laser signal R to the bandpass filter BF5 which is operative or configured for reflecting optical or laser signals R1 and R3 to the bandpass filter BF6 via the first and second reflective elements and for passing the optical or laser signal R2;
the bandpass filter BF6 is operative or configured for reflecting the optical or laser signal R3 to the bandpass filter BF7 and for passing the optical or laser signal R1; and
the bandpass filter BF7 is operative or configured for passing the optical or laser signal R3.

2. The optical multiplexer-demultiplexer system of claim 1, further including a mirror M3 operative or configured for reflecting the optical or laser signal R3 prior to the optical or laser signal R3 exiting the optical demultiplexer.

3. The optical multiplexer-demultiplexer system of claim 1, further including a mirror M4 operative or configured for reflecting the optical or laser signal R2 prior to the optical or laser signal R2 exiting the optical demultiplexer.

4. The optical multiplexer-demultiplexer system of claim 1, further including a mirror M5 operative or configured for reflecting the optical or laser signal R1 prior to the optical or laser signal R1 exiting the optical demultiplexer.

5. The optical multiplexer-demultiplexer system of claim 1, wherein the first and second reflective elements are mirrors M1 and M2.

6. The optical multiplexer-demultiplexer system of claim 1, wherein the first and second reflective elements are bandpass filters BF8 and BF9.

7. The optical multiplexer-demultiplexer system of claim 1, wherein at least one of the following:
the optical or laser signals R1, R2 and R3 have wavelengths of 1270±10 nm, 1286±2 nm, and 1310±20 nm; and
the optical or laser signals T1, T2 and T3 have wavelengths of 1342+2 nm, 1490±10 nm, and 1577±2.5 nm.

8. The optical multiplexer-demultiplexer system of claim 1, wherein the optical multiplexer is operative or configured to:
after passage of optical or laser signal T1 through the bandpass filter BF1, reflect the optical or laser signal T1 to bandpass filter BF2 which reflects and combines the optical or laser signal T1 with the optical or laser signal T2 after passage of the optical or laser signal T2 through the bandpass filter BF2, and
reflect the combined optical or laser signals T1 and T2 to bandpass filter BF3 which, after passage of the optical or laser signal T3 through bandpass filter BF3, reflects and combines the optical or laser signal T3 with the combined optical or laser signals T1 and T2 to form the single output optical or laser signal O1.

9. The optical multiplexer-demultiplexer system of claim 1, wherein at least one of the optical multiplexer and the optical demultiplexer is a glass substrate.

10. An optical multiplexer-demultiplexer system comprising:
an optical multiplexer system comprising an optical multiplexer and bandpass filters BF1, BF2 and BF3 operative or configured for bandpass filtering input optical or laser signals T1, T2 and T3 having different wavelengths prior to entry into the optical multiplexer, wherein the optical multiplexer is operative or configured for combining the bandpass filtered input optical or laser signals T1 and T2 after reflection of the bandpass filtered optical or laser signal T1, for combining the bandpass filtered input optical or laser signal T3 with the combined bandpass filtered input optical or laser signals T1 and T2 after reflection of the combined bandpass filtered input optical or laser signals T1 and T2, and for outputting the combined bandpass filtered input optical or laser signals T1, T2 and T3 as a single output optical or laser signal O1; and
an optical demultiplexer system comprising bandpass filters BF4, BF5, BF6 and BF7, an anti-reflective (AR) coating, and an optical demultiplexer operative or configured for receiving the single output optical or laser signal O1 after passage through the bandpass filter BF4, wherein the optical demultiplexer is operative or configured for passing the single output optical or laser signal Ol to a COM port of the optical demultiplexer via the AR coating, wherein:
the optical demultiplexer is also operative or configured for receiving on the COM port an input optical or laser signal R comprising different wavelength optical or laser signals R1, R2 and R3, to pass the input optical or laser signal R to the bandpass filter BF4 after passage of the input optical or laser signal R via the AR coating;
the bandpass filter BF4 is operative or configured to reflect the input optical or laser signal R to the bandpass filter BF5 which is operative or configured for reflecting optical or laser signals R1 and R3 to the bandpass filter BF6 via first and second reflective elements of the optical demultiplexer and for passing the optical or laser signal R2;
the bandpass filter BF6 is operative or configured for reflecting the optical or laser signal R3 to the bandpass filter BF7 and for passing the optical or laser signal R1; and
the bandpass filter BF7 is operative or configured for passing the optical or laser signal R3.

11. The optical multiplexer-demultiplexer system of claim 10, wherein the optical demultiplexer system includes a mirror M3 for reflecting the optical or laser signal R3.

12. The optical multiplexer-demultiplexer system of claim 10, wherein the optical demultiplexer system includes a mirror M4 for reflecting the optical or laser signal R2.

13. The optical multiplexer-demultiplexer system of claim 10, wherein the optical demultiplexer system includes a mirror M5 for reflecting the optical or laser signal R1.

14. The optical multiplexer-demultiplexer system of claim 10, wherein the first and second reflective elements are mirrors M1 and M2.

15. The optical multiplexer-demultiplexer system of claim 10, wherein the first and second reflective elements are bandpass filters BF8 and BF9.

16. The optical multiplexer-demultiplexer system of claim 10, wherein at least one of the following:
the optical or laser signals R1, R2 and R3 have wavelengths of 1270±10 nm, 1286±2 nm, and 1310±20 nm; and
the optical or laser signals T1, T2 and T3 have wavelengths of 1342±2 nm, 1490±10 nm, and 1577±2.5 nm.

17. An optical multiplexer-demultiplexer system comprising:
an optical multiplexer (Tx) having a Tx body including a Tx1 surface and a Tx2 surface, and bandpass filters BF1, BF2 and BF3 disposed on the Tx1 surface for receiving input optical or laser signals T1, T2 and T3, respectively, wherein:
the input optical or laser signals T1, T2 and T3, after passage through the bandpass filters BF1, BF2 and BF3, enter the Tx1 surface and pass through the Tx body, wherein the input optical or laser signal T1, after reflection at the Tx2 surface back to the Tx1 surface via the Tx body, is combined with the input optical or laser signal T2 entering the Tx1 surface, wherein the combined input optical or laser signals T1 and T2, after reflection at the Tx2 surface back to the Tx1 surface via the Tx body, is combined with the input optical or laser signal T3 entering the Tx1 surface, wherein the combined input optical or laser signals T1, T2, and T3 exit the Tx2 surface via the Tx body as an output optical or laser signal O1;
and
an optical demultiplexer (Rx) having an Rx body including an Rx1 surface and an Rx2 surface, bandpass filters BF4 and BF6 disposed on the Rx1 surface, and bandpass filters BF5 and BF7 and an anti-reflective (AR) coating disposed on the Rx2 surface, wherein the optical demultiplexer is operative or configured for receiving and passing the single output optical or laser signal O1 to a COM port of the optical demultiplexer system via the Rx body and the AR coating after passage of the single output optical or laser signal O1 through the bandpass filter BF4, wherein:
the optical demultiplexer is also operative or configured to receive on the COM port an input optical or laser signal R comprising different wavelength optical or laser signals R1, R2 and R3, to pass the input optical or laser signal R to the bandpass filter BF4 via the AR coating and the Rx body;
the bandpass filter BF4 is operative or configured to reflect the input optical or laser signal R to the bandpass filter BF5 via the Rx body;
the bandpass filter BF5 is operative or configured for reflecting optical or laser signals R1 and R3 to the bandpass filter BF6 via first and second reflective elements and for passing the optical or laser signal R2;
the bandpass filter BF6 is operative or configured for reflecting the optical or laser signal R3 to the bandpass filter BF7 and for passing the optical or laser signal R1; and
the bandpass filter BF7 is operative or configured for passing the optical or laser signal R3.

18. The optical multiplexer-demultiplexer system of claim 18, wherein:
the Tx1 and Tx2 surfaces are disposed or positioned in spaced relation or spaced parallel relation; and
the Rx1 and Rx2 surfaces are disposed or positioned in spaced relation or spaced parallel relation.

19. A method of optical multiplexing and demultiplexing optical or laser signals with an optical multiplexer (Tx) having a Tx body including a Tx1 surface, a Tx2 surface and bandpass filters BF1 and BF3 disposed on the Tx1 surface, and an optical demultiplexer (Rx) having an Rx body including an Rx1 surface and an Rx2 surface, bandpass filter BF4 and BF6 disposed on the Rx1 surface and a bandpass filter BF5 disposed on the Rx2 surface, the method comprising:
a) inputting, via the Tx1 surface, different wavelength optical or laser signals T1 and T3 into the Tx body via the respective bandpass filters BF1 and BF3;
b) combining, at or adjacent the Tx1 surface, reflections of the optical or laser signal T1 by or adjacent the Tx2 surface and the bandpass filter BF3 with the optical or laser signal T3 entering the Tx1 surface;
c) outputting, via the optical demultiplexer Rx after passage through the Tx2 surface, the bandpass filter BF4, the Rx1 surface and the Rx2 surface, the combined optical or laser signals T1 and T3 of step b);
d) inputting, via the Rx2 surface, an optical or laser signal R comprising different wavelength optical or laser signals R1 and R2;
e) reflecting, by the bandpass filter BF4, the optical or laser signal R of step d) to the bandpass filter BF5 via the Rx body;
f) following step e), by the bandpass filter BF5, passing the optical or laser signal R2 and reflecting the optical or laser signals R1 to the bandpass filter BF6 via the Rx body;
g) following step f), by the bandpass filter BF6, passing the optical or laser signal R1.

20. The method of claim 19, wherein the method includes, between steps f) and g), reflecting, by one or more reflective elements, the optical or laser signal R1.
